(19) United States
(12) Patent Application Publication
(10) Pub. No.: US 2007/0240424 A1
(43) Pub. Date: Oct. 18, 2007

(54) Gas turbine engine having bypass ducts

(76) Inventors: Alfred P. Matheny, Jupiter, FL (US); John E. Ryznic, Palm Beach Gardens, FL (US)

Correspondence Address: John Ryznic;Florida Turbine Technologies, Inc., Suite 301, 140 Intracoastal Pointe Drive, Jupiter, FL, 33477, US

(21) Appl. No.: 11/206,470

(22) Filed: Aug. 18, 2005

Related U.S. Application Data
(60) Provisional application No. 60/603,693, filed on Aug. 23, 2004.

(51) Int. Cl. F02K 3/02

(52) U.S. Cl. 60/772; 60/262

(57) ABSTRACT

A gas turbine engine having a bypass flow in which the bypass flow includes a central bypass passage formed by a rotary shaft of the engine, and an outer bypass passage located between the casing and the combustor, where the hot gas stream from the turbine is located between the outer bypass flow and the central bypass flow. Also, a gas turbine engine having a central bypass passage with a single spool or twin spools, in which various ways are arranged to support the rotary members of the engine.

### CROSS-REFERENCE TO RELATED APPLICATIONS

This application claims the benefit to co-pending Provisional Application No. 60/603,693 filed on Aug. 23, 2004 and entitled Gas Turbine Engine Having Bypass Ducts.

### BACKGROUND OF THE INVENTION

1. Field of the Invention

The present invention relates to gas turbine engines of the turbofan type, and specifically a turbofan engine that has an inner bypass duct and an outer bypass duct combined in the engine.

2. Description of the Related Art Including Information Disclosed Under 37 CFR 1.97 and 1.98

Turbofan (or bypass) engines are well known in the prior art, in which a fan is included in the compressor/combustor/turbine assembly to provide airflow around the compressor/combustor/turbine portion. This arrangement is disclosed in U.S. Pat. No. 5,692,372 issued on Dec. 2, 1997 to Whurr and shown in FIG. 25. This outer bypass is used in most commercial aircraft engines for the purpose of providing high power at takeoff and low noise during operation.

Gas turbine engines having a central bypass duct are also known in the prior art. U.S. Pat. No. 6,532,731 issued to Springer on Mar. 18, 2003 (shown in FIG. 26 and U.S. Pat. No. 6,151,882 issued to Cavanagh on Nov. 28, 2000 (shown in FIG. 27) show gas turbine engines having a bypass extending through the central portion of the engine, radially inward of the compressor/combustor/turbine portions.

It is an object of the present invention to provide for gas turbine engine to have a greater bypass flow without increasing the radial size of the engine by incorporating a central bypass in a gas turbine engine.

It is also an object of the present invention to improve the efficiency of the high pressure compressor of a gas turbine engine by replacing standard centrifugal compressor with a high efficiency axial compressor.

It is also an object of the present invention to provide for a higher volume combustor with a reduced axial length to shorten the engine.

It is also an object of the present invention to provide for the fan blades have a shorter radial length which will allow for stiffer and higher frequency blades, and allow the turbine engine to operate under faster revolutions and/or increasing the potential operating range of the engine.

It is also an object of the present invention to provide for noise reduction and cooling of the outer combustor wall by including an outer bypass to the inner bypass flow in which the bypass flow mix to reduce turbine exhaust noise.

It is also an object of the present invention to provide for several embodiments of a central bypass gas turbine engine in which the bypass fans blades are supported in the engine.

These and other objects of the present invention will be described below in the Detailed Description of the Present Invention.

### BRIEF SUMMARY OF THE INVENTION

The present invention in a gas turbine engine with both a central and an outer bypass flow to produce a high mass flow through the bypass and a minimum cross-sectional area for the engine.

The present invention also shows a gas turbine engine having a central bypass duct with several arrangements of the bearing supports for the spools and the bypass fans. Some fans are located forward of the combustor while some fans are located rearward. Other embodiments show various arrangements for the combustor chamber. These various arrangements for the bearings and the combustor chambers allow for the gas turbine engine having a central bypass duct to have several different configurations in order to be customized for different engine requirements.

### BRIEF DESCRIPTION OF THE SEVERAL VIEWS OF THE DRAWINGS

FIG. 1 shows a first embodiment of the present invention in which a gas turbine engine having a single spool includes an outer bypass and a central bypass for airflow through the engine.

FIG. 2 shows a second embodiment of the present invention in which the gas turbine engine having two spools includes an outer bypass and a central bypass for airflow through the engine.

FIG. 3 shows a variation of the second embodiment in FIG. 5 with a different arrangement of the bearings.

FIG. 4 shows an outer circumferential view of the fan blade assembly being formed of a splitter blade.

FIG. 5 shows a gas turbine engine of the present invention having two spools and a central bypass, and guide vanes before the compressor and the turbine, where the bypass fan being located forward of the combustor.

FIG. 6 shows a variation of the gas turbine engine of FIG. 8 in which a mixer is used to combine the flow from the central bypass and the turbine exhaust.

FIG. 7 shows a variation of the gas turbine engine of FIG. 9 in which the combustor chamber is different.

FIG. 8 shows a gas turbine engine of FIG. 10 with a different fan blade structure.

FIG. 9 shows the gas turbine engine of FIG. 11 with a different fan blade structure.

FIG. 10 shows the gas turbine engine of FIG. 12 with a different combustor chamber configuration.

FIG. 11 shows the gas turbine engine with a single spool and a central bypass duct, a guide vane before each of the compressor and turbine, two turbine blades, and a fan blade arrangement located forward of the combustor.

FIG. 12 shows the gas turbine engine of FIG. 14 with only one turbine blade.

FIG. 13 shows the gas turbine engine of FIG. 15 with a smaller cross sectional flow path through the compressor/combustor/turbine section.

FIG. 14 shows a gas turbine engine of FIG. 16 with a different mixer assembly.

FIG. 15 shows a gas turbine engine of FIG. 17 with a smaller cross sectional flow path through the compressor/combustor/turbine section.

FIG. 16 shows a gas turbine engine with two spools and a central bypass duct, and a bypass fan located rearward of the combustor.

FIG. 17 shows the gas turbine engine of FIG. 19 with a longer combustion chamber.

FIG. 18 shows a gas turbine engine having two spools and a bypass duct, a fan blade located upstream of the combustor, and a mixer assembly to mix the fan bypass flow and the turbine exhaust flow.

FIG. 19 shows the gas turbine engine of FIG. 21, with arrows indicating flow paths for the bypass flow and the turbine exhaust.

FIG. 20 shows a gas turbine engine with two spools and a central bypass duct, guide vanes upstream of the compressor and the turbine, and a fan assembly upstream of the compressor.

FIGS. 21 and 22 shows a gas turbine engine of FIG. 23 with a different combustor chamber arrangement.

FIG. 23 shows a turbine with twin spools and a central bypass duct having fan blades extending all the way through.

FIG. 24 shows a turbine with twin spools and a central bypass duct having a fan blade in the upstream entrance to the duct and a fan blade in the downstream exit of the duct, the exit of the duct turning upward to mix the bypass flow with the turbine exhaust flow.

FIG. 25 shows the prior art gas turbine engine (U.S. Pat. No. 5,692,372 issued to Whurr) with an outer bypass duct.

FIG. 26 and 27 show the prior art gas turbine engines (U.S. Pat. No. 6,532,731 issued to Springer; U.S. Pat. No. 6,151,882 issued to Cavanagh) with a central bypass duct.

### DETAILED DESCRIPTION OF THE INVENTION

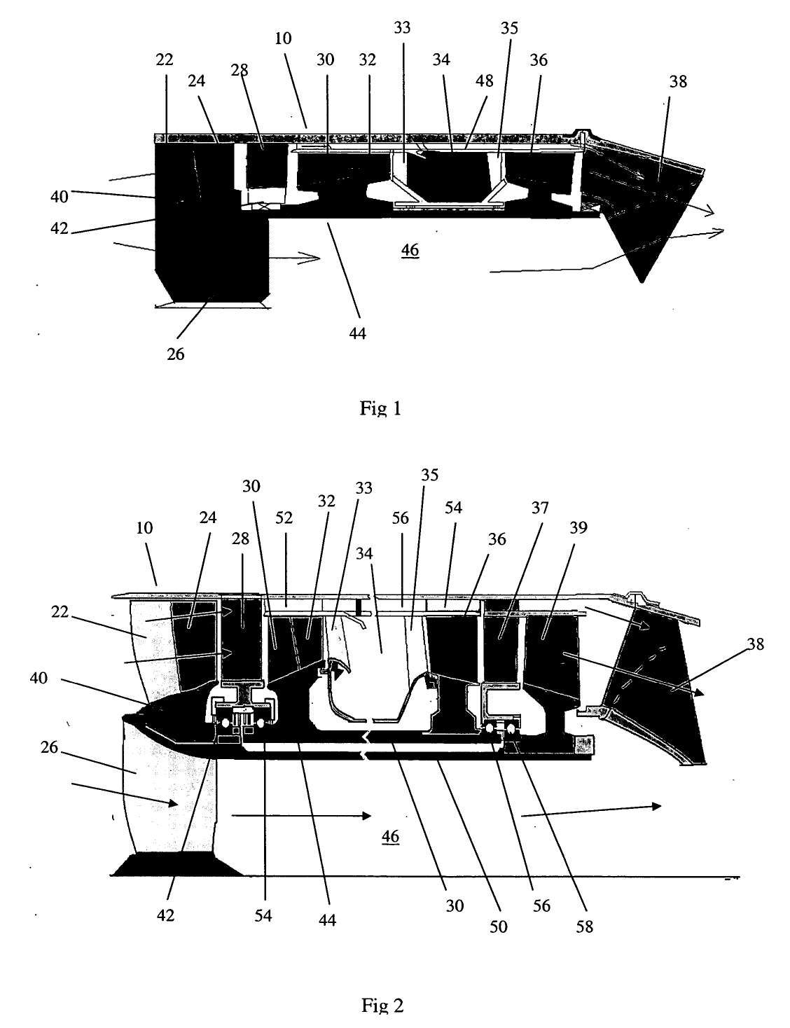

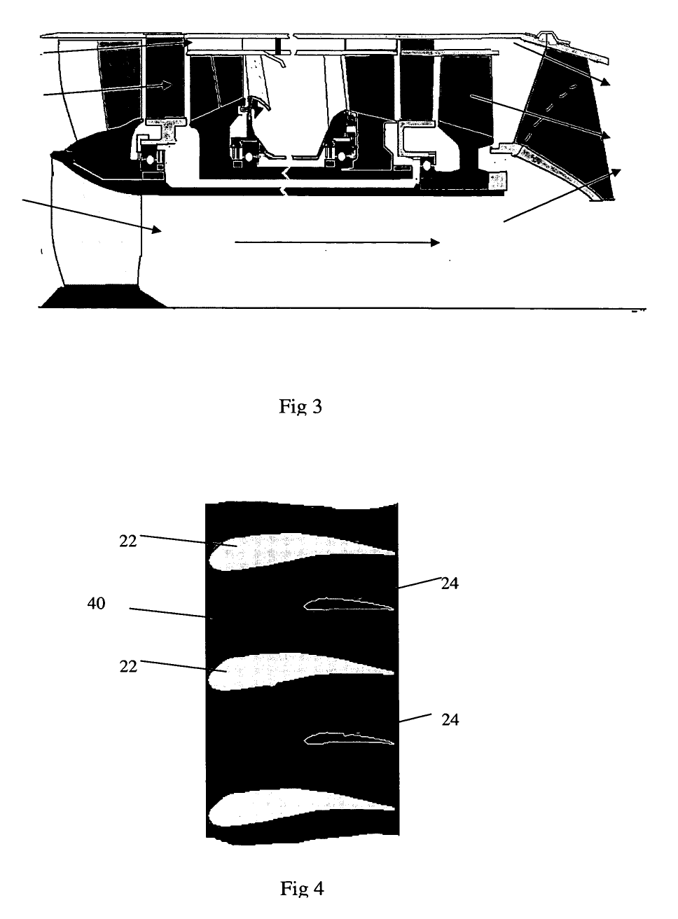

The gas turbine engine of the present invention is best shown in FIGS. 1-3. FIG. 1 shows a turbine with a single spool and bypass ducts through the central portion and outer portions of the turbine engine. FIGS. 2 and 3 show gas turbine engines with two spools and central and outer bypass ducts, but with different bearing arrangements to support the two spools.

The gas turbine engine of FIG. 1 shows a single spool turbine with a central bypass duct 46 and an outer bypass duct formed between outer casing 10 and member 48. In this embodiment, the outer bypass duct is of such size that the airflow through it is enough to provide a stream of air to surround the exhaust gas flow from the turbine in order to reduce noise. The outer bypass flow is not sized such that much thrust is provided form the outer duct airflow as would be provided due to the central duct airflow.

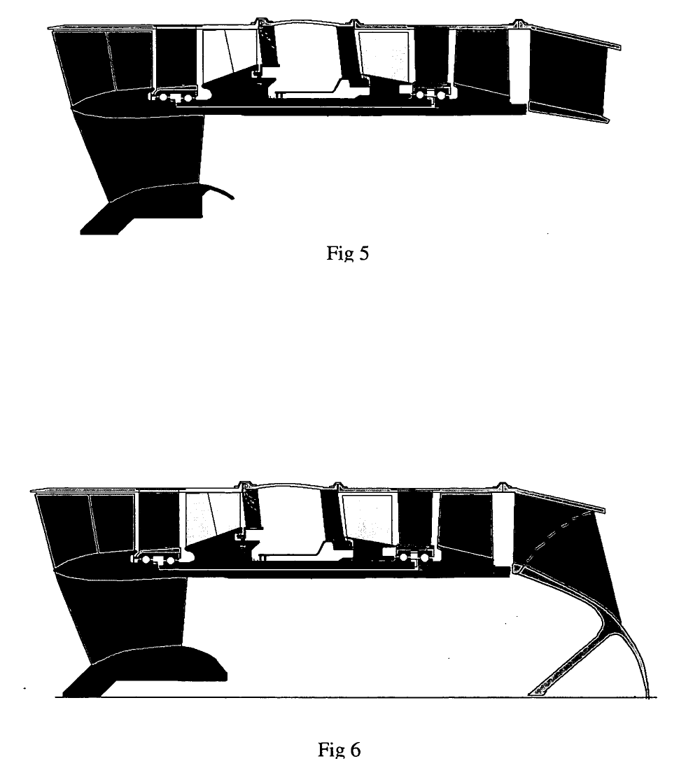

A fan blade comprises blade 22 and blade 24 extending from a shaft 44. Blade 22 has a longer cord length than blade 24, the blade arrangement forming a splittered rotor as disclosed in U.S. Pat. No. 5,299,914 issued to Schilling on Apr. 5, 1994 and incorporated herein by reference. FIG. 4 shows this blade arrangement. A bypass fan blade 26 is also connected to the shaft 44 and provides the bypass flow through the central bypass passage 46. A guide vane 28 is secured to the outer casing 10 and is located upstream of compressor blades 30 and 32. Blades 30 and 32 also form a splittered rotor arrangement for the compressor blade rotor. A combustor 34 is located downstream from the compressor blades 30 and 32. Combustor guide vane 33 guides the flow into the combustor, while turbine nozzle 35 directs the combustor exhaust gas flow to the turbine. Turbine blade 46 is located downstream from the combustor 34 and nozzle 35. Both the compressor rotor with blades 30 and 32 and the turbine rotor with blade 36 are rotatably secured to shaft 44. Combustor 34 is secured to the outer casing 10 via the casing member 48. Casing member 48 is secured to the inner wall of the outer casing by struts or other joining members that are of low resistance to airflow through the outer bypass duct. Rotation of the shaft 44 causes the fan blades 22, 24, and 26 to rotate and force airflow into the outer bypass duct, the compressor, and the central bypass duct. An exhaust mixer 38 is located downstream of the turbine, and is secured to the outer casing 10. Airflow from both ducts and the turbine are combined to reduce noise. The spool shaft 44 is supported for rotation by bearings 42 and 43. The guide vane 28 supports bearing 42, while the mixer 38 supports bearing 43.

The FIG. 2 embodiment shows a turbine engine having two spools with a central bypass duct and an outer bypass duct of larger flow volume than the first embodiment FIG. 1. A fan arrangement includes blades 22, 24, and 26, where blades 22 and 24 are of the splittered rotor type blade set as shown in FIG. 4. Blades 22, 24, and 26 are rotatably secured to hub 40 that is joined to shaft 50 forming the innermost spool. Compressor guide vane 28 is secured to the outer casing 10, as is the turbine guide vane 37. The inner spool includes compressor blades 30 and 32 forming a spluttered blade set as shown in FIG. 4, and turbine blade 36. Guide vanes 33 and nozzles 35 are used as in the FIG. 1 embodiment. In the FIG. 2 embodiment, the guide vanes 28 and 37 support bearings 42, 54, 56, and 58 that support the two spools having shafts 44 and 50. A combustor section 34 is located between the compressor and the turbine, and a mixer 38 is located downstream of the turbine to mix the bypass flow and the exhaust flow from the turbine. Casing member 48 is secured to the outer casing 10 by struts 52 and 54, these struts providing structural support for the casing member 48 and the combustor 34 while minimizing the airflow resistance through the outer bypass duct 56. Rotation of the turbine blade 36 causes the compressor blades 30 and 32 to rotate, while rotation of the turbine blade 39 causes rotation of the fan blades 22, 24, and 26.

The FIG. 3 embodiment differs from the FIG. 2 embodiment in the bearing arrangement that supports the spool carrying the compressor and turbine blades. FIG. 3 includes structure similar to that in FIG. 2, and therefore the reference numerals are not shown. The FIG. 3 embodiment differs from that of FIG. 2 in that the outer spool is supported by bearings that are supported on the combustor and guide vane and nozzle. The inner spool having inner shaft supports the fan blades, and is supported by bearings and carried on the guide vanes. The outer spool having outer shaft supports the compressor blades, and the turbine blade. The outer shaft is supported by bearings and that are supported on the combustor casing. The guide vanes are secured to the outer casing and the combustor casing is secured to the inner casing member. The inner casing member is secured to the outer casing by struts as disclosed above in the FIG. 2 embodiment. A mixer is located downstream of the turbine, and mixes the bypass flows and the exhaust from the turbine to reduce noise. Outer bypass duct is formed between outer casing and middle casing member. Inner spool or shaft forms central bypass duct. Rotation of the turbine blade causes the compressor blades to rotate, while rotation of the turbine blade causes rotation of the fan blades.

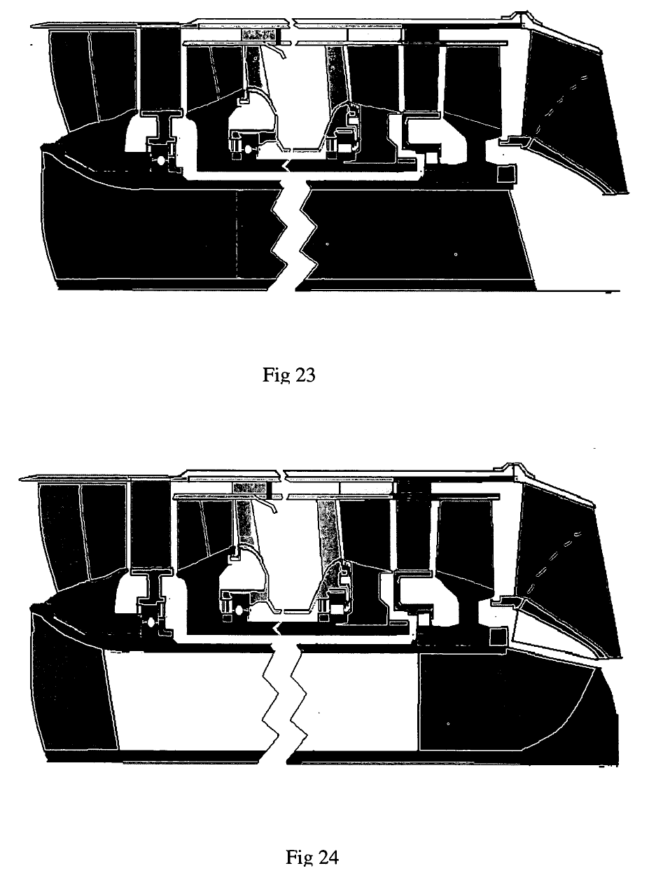

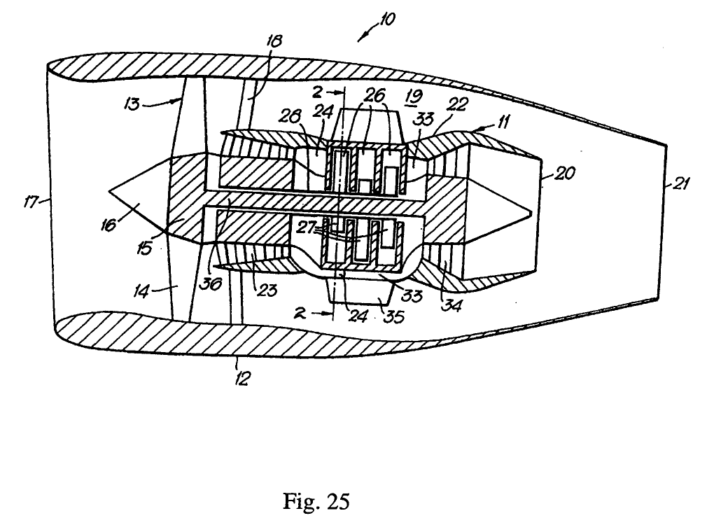

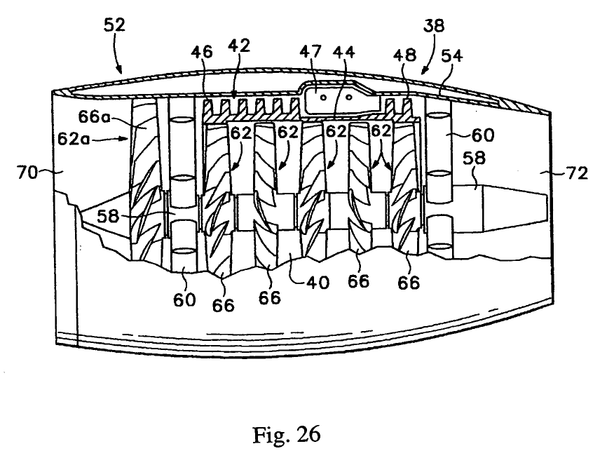

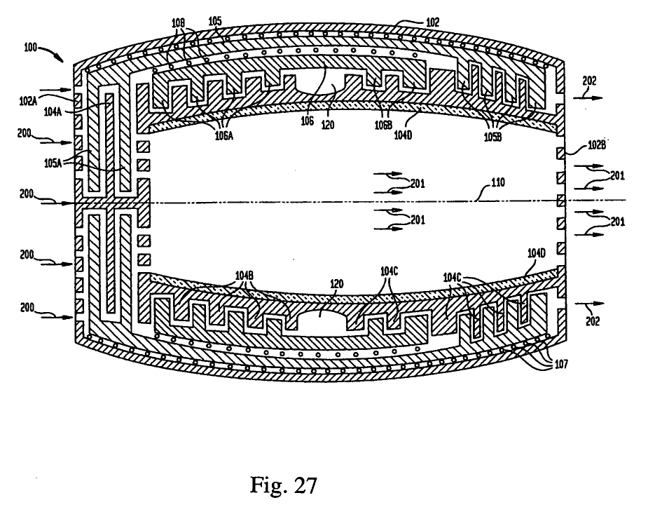

FIGS. 23 and 24 show a turbine having twin spools and a central bypass duct. The combustor carries two bearings that support the outer spool carrying the compressor blade and the first stage turbine blades. The guide vanes support the bearings that support the inner spool carrying the fan blades and the second stage turbine blade. The central bypass duct includes a blade set that passes from the entrance to the exit of the duct.

In the FIG. 24 embodiment, the central bypass duct has a blade in the entrance of the duct and another blade at the exit of the duct with an open passage between these two blades. Also, the exit of the central bypass duct is turned upward to mix the bypass airflow with the exhaust from the turbine.

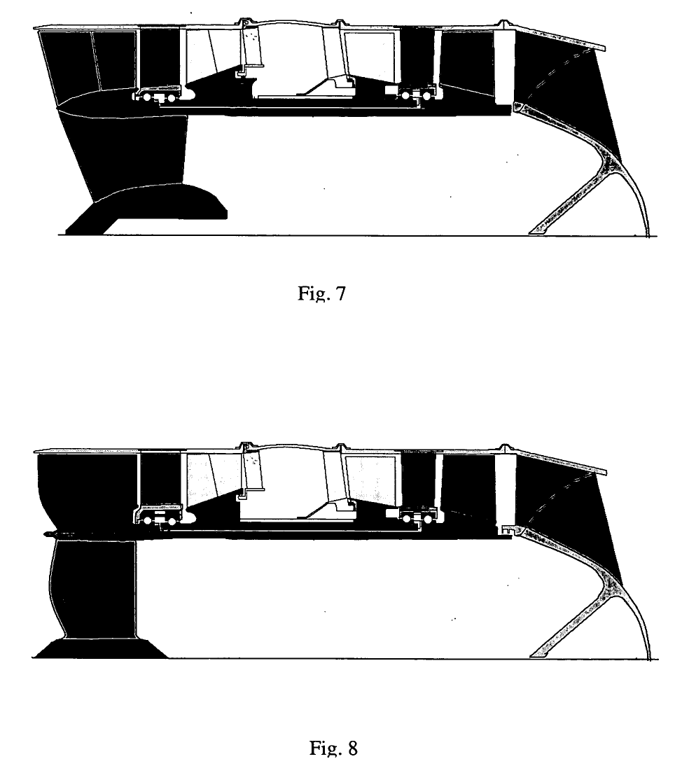

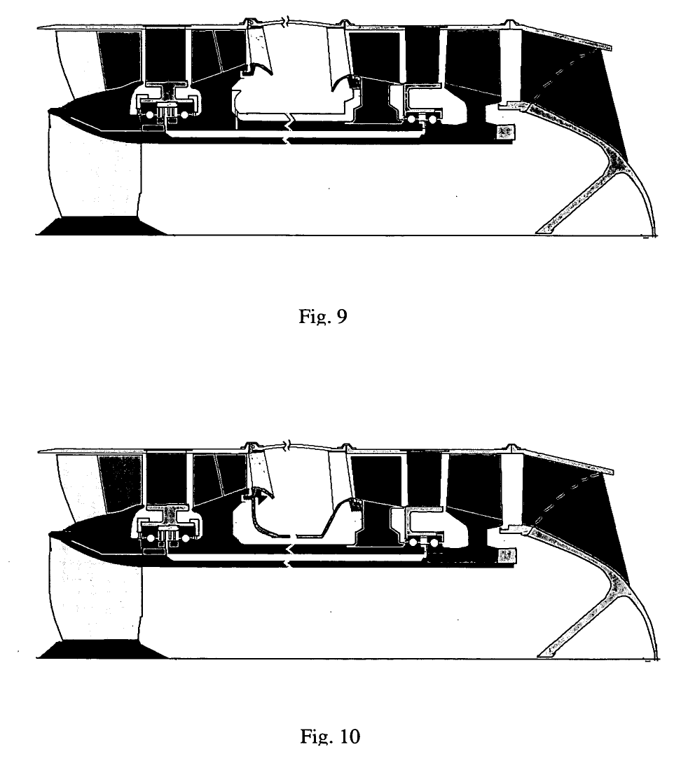

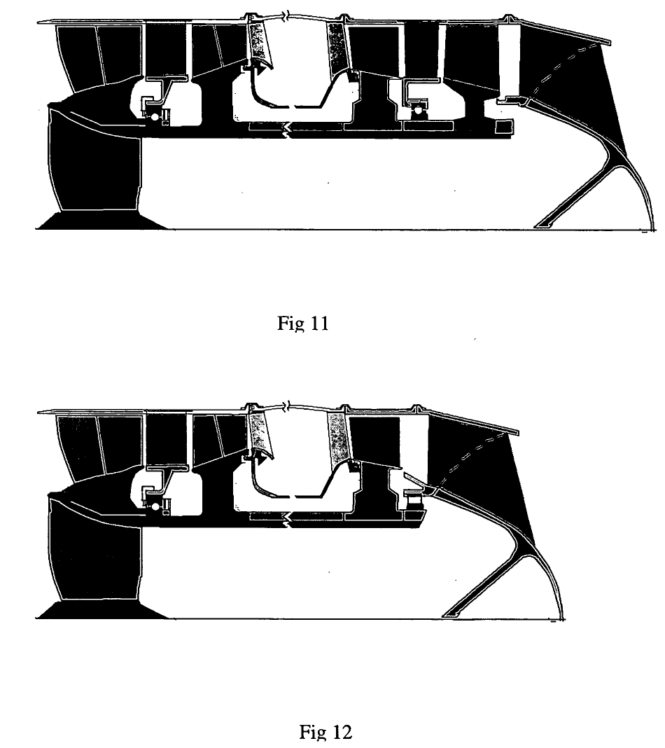

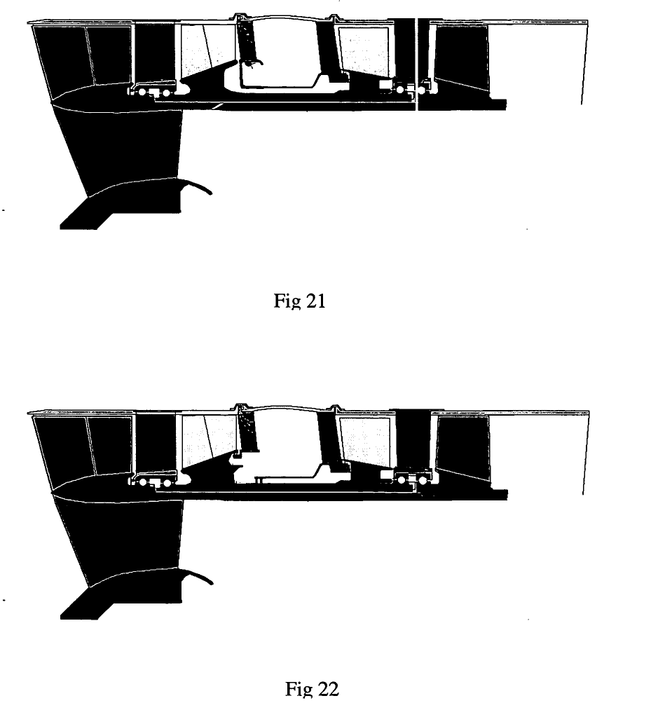

FIGS. 2-20 show embodiments of a gas turbine engine having a central bypass duct with various structures for the rotational support of shafts and various arrangements for the fan blades. FIG. 2 shows a turbine with two spools and a fan blade assembly located upstream of the combustor, and the spools being supported by bearings carried on the vanes. FIG. 3 shows a twin spool turbine like FIG. 2 but with a mixer located downstream of the turbine. FIG. 4 shows the turbine of FIG. 3, but with a modified combustion chamber arrangement. FIG. 5 shows the turbine of FIG. 4, but with fan blades having a leading edge curved in the radial direction. FIG. 6 shows a turbine with twin spools supported for rotation by bearings carried on the vanes, and a modified combustion chamber arrangement. FIG. 7 shows the turbine of FIG. 6, but with a further modification of the combustion chamber arrangement. FIG. 8 shows a turbine with a single spool and vanes that carry bearing to support rotation of the spool or shaft. FIG. 9 shows the turbine of FIG. 8, but with the rear bearing carried by the mixer frame. FIG. 10 shows a turbine of FIG. 9, but with a flow passage area through the compressor/turbine portion of smaller volume. FIG. 11 shows a turbine of the FIG. 9 embodiment, but with a flow passage area through the compressor/turbine portion of smaller volume than the FIG. 10 embodiment. FIG. 12 shows a turbine of the FIG. 9 embodiment, but with a flow passage area through the compressor/turbine portion of smaller volume than the FIG. 11 embodiment.

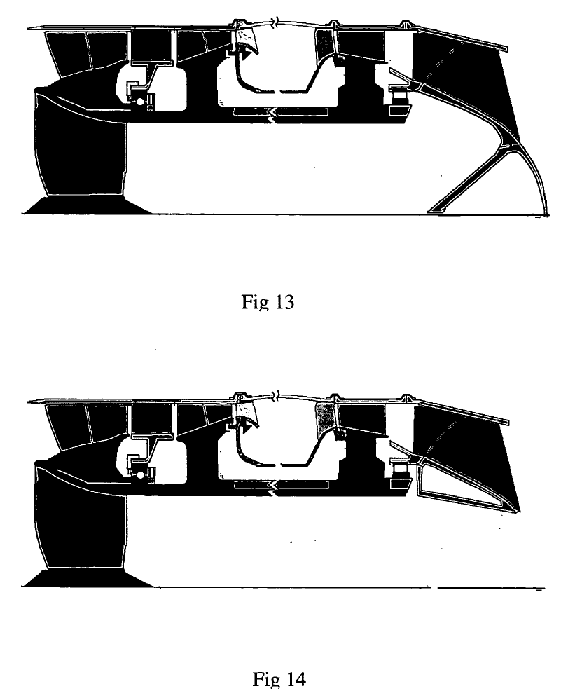

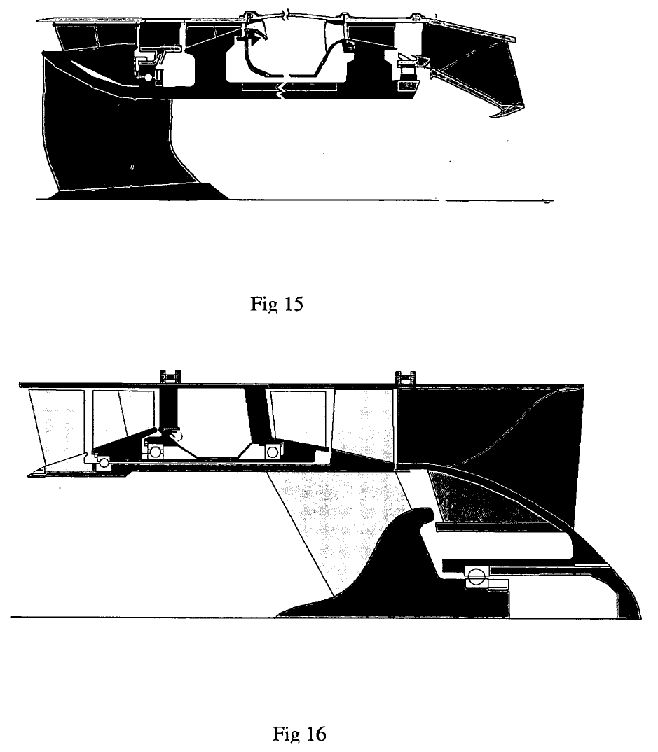

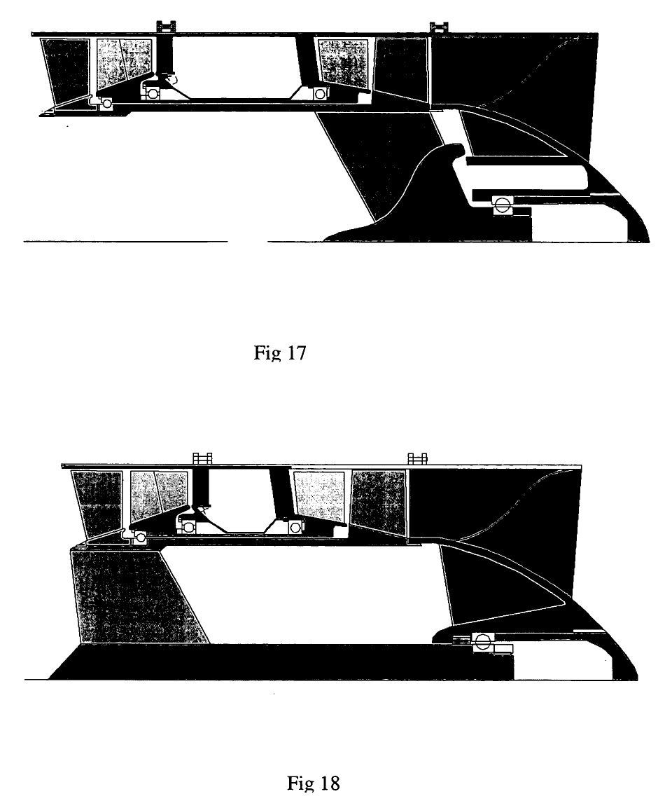

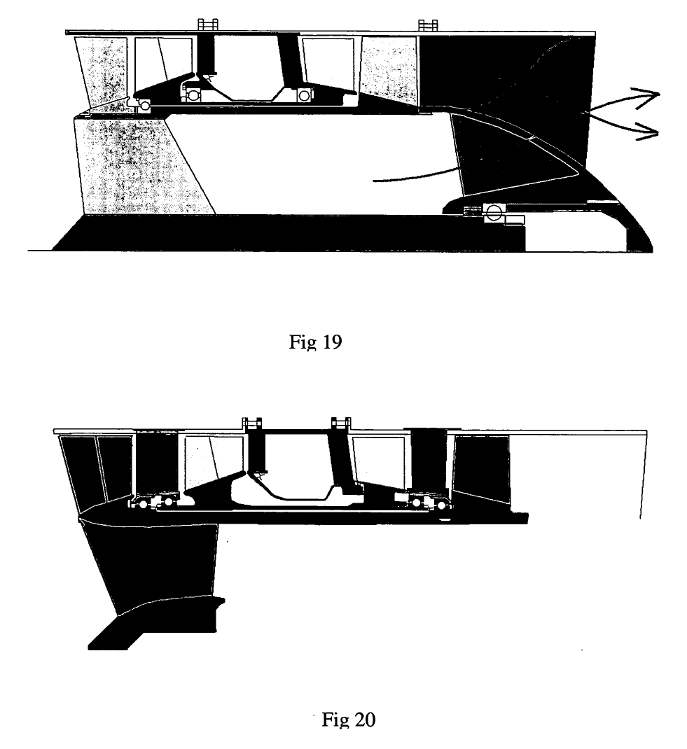

FIG. 13 shows a turbine having twin spools, where the inner spool is supported by bearings carried on the combustor assembly, while the outer spool is supported by bearings carried on the inner spool (front bearing) and the mixer frame (rear bearing). The fan blades are located downstream of the combustor. FIG. 14 shows a turbine of the embodiment in FIG. 13, but with a longer combustion chamber. FIG. 15 shows a turbine with twin spools of the FIG. 14 embodiment, but with the fan blades are located upstream of the combustor and are carried on a shaft that supports the rear bearing of the inner spool or shaft. FIG. 16 shows the air flow paths through the mixer of the FIG. 15 embodiment. FIG. 17 shows a turbine with twin spools and vanes that carry the bearings, the fan blades are located upstream of the combustor. FIG. 18 shows a turbine of the FIG. 17 embodiment, but with a modified combustor shape. FIG. 19 shows a turbine of the FIG. 18 embodiment, but with a further modified combustor shape.

We claim the following:

1. A gas turbine engine comprising:
A compressor to compress air;
A combustor to burn the compressed air from the compressor with a fuel;
A turbine to react with a gas stream from the combustor;
A bypass fan to supply a bypass flow;
A central bypass passage to direct a bypass flow through the engine; and,
An outer bypass passage to direct a bypass flow through the engine.

2. The gas turbine engine of claim 1, and further comprising:
The bypass fan, and the compressor blades, and the turbine blades are supported by a rotary shaft, the rotary shaft being rotationally supported by bearings, the bearings being supported by a guide vane located upstream of the compressor and an exhaust mixer located downstream of the turbine blades.

3. The gas turbine engine of claim 1, and further comprising:
A high pressure compressor blade and a high pressure turbine blade being supported by an outer spool;
The fan blade and a low pressure turbine blade being supported by an inner spool;
The inner spool and the outer spool both being rotationally supported by bearings provided on a guide vane located upstream of the compressor and a turbine vane located between the high pressure turbine blade and the low pressure turbine blade.

4. The gas turbine engine of claim 1, and further comprising:
A high pressure compressor blade and a high pressure turbine blade being supported by an outer spool;
The fan blade and a low pressure turbine blade being supported by an inner spool;
The outer spool being rotatably supported by bearings provided on a guide vane located downstream of the high pressure compressor and a nozzle located upstream of the high pressure turbine; and,
The inner spool being rotatably supported by bearings provided on a guide vane located upstream of the compressor and a guide vane located between the high pressure turbine blade and the low pressure turbine blade.

5. The gas turbine engine of claim 1, and further comprising:
The bypass fan comprising a spluttered blade set extending radially outward from a hub on the rotary shaft, and a bypass fan blade extending radially inward from the hub.

6. The gas turbine engine of claim 1, and further comprising:
An exhaust mixer located downstream of the turbine, the exhaust mixer comprising means to mix the gas stream from the turbine with the bypass flow from the outer bypass passage and the inner bypass passage.

7. The gas turbine engine of claim 1, and further comprising:
The central passage is formed by a rotary shaft of the bypass fan, the compressor and the turbine.

8. The gas turbine engine of claim 3, and further comprising:
The central passage is formed by the inner spool.

9. A gas turbine engine comprising a compressor, a combustor, a turbine, and a central bypass passage, the improvement comprising:
A first bearing support located upstream of the combustor;
A second bearing support located downstream of the combustor;
Bearing means supported by the bearing supports;
A bypass fan supported for rotation by a rotary shaft; and,
The rotary shaft supported by the bearing means.

10. The gas turbine engine of claim 9, and further comprising:
The compressor and the turbine are rotatably supported by the rotary shaft.

11. The gas turbine engine of claim 9, and further comprising:
The rotary shaft forms the central bypass passage.

12. The gas turbine engine of claim 9, and further comprising:
The first bearing support is a guide vane located upstream of the compressor; and,
The second bearing support is a nozzle located downstream of the turbine.

13. The gas turbine engine of claim 9, and further comprising:
The first bearing support is a guide vane located upstream of the compressor; and,
The second bearing support is a mixer located downstream of the turbine.

14. The gas turbine engine of claim 9, and further comprising:
The bypass fan comprises a splittered fan secured to a hub extending in a radial outward direction from the hub, and a fan blade secured to the hub and extending in a radial inward direction from the hub.

15. A two-spool gas turbine engine comprising a compressor, a combustor, a turbine, and a central bypass passage, the improvement comprising:
A first bearing support, located upstream of the combustor, to support a first bearing assembly;
A second bearing support, located downstream of the combustor, to support a second bearing assembly;
The outer spool having a compressor blade and a high pressure turbine blade rotatably secured thereto;
The inner spool having a bypass fan and a low pressure turbine blade rotatably secured thereto;
Both the inner spool and the outer spool being supported by the first and second bearing assemblies; and,
The inner spool forming the central bypass passage.

16. The two-spool gas turbine engine of claim 15, and further comprising:
The first bearing support being a guide vane; and,
The second bearing support being a nozzle located between the high pressure turbine blade and the low pressure turbine blade.

17. The two-spool gas turbine engine of claim 15, and further comprising:
The bypass fan comprises a splittered fan to supply air to the compressor and a fan blade to supply air to the central bypass passage.

18. The two-spool gas turbine engine of claim 15, and further comprising:
A mixer located downstream of the turbine and the central bypass passage to mix the bypass flow with the turbine exhaust.

19. A two-spool gas turbine engine comprising a compressor, a combustor, a turbine, and a central bypass passage, the improvement comprising:
The outer spool rotatably supporting a high pressure compressor blade and a high pressure turbine blade;
First and second bearing support means to support bearings for the outer spool;
The inner spool rotatably supporting a low pressure compressor blade and a low pressure turbine blade;
A third bearing means located on a forward end of the outer spool to rotatably support the inner spool;
A mixer located downstream of the turbine to mix the turbine exhaust with the bypass flow;
A fourth bearing means located on the mixer to rotatably support the inner spool; and,
A fan blade on the inner spool.

20. The two-spool gas turbine engine of claim 19, and further comprising:
The inner spool forms the central bypass passage; and,
The fan blade is located near an aft end of the inner spool and acts to draw the bypass flow through the central bypass passage.

21. The two-spool gas turbine engine of claim 19, and further comprising:
The inner spool forms the central bypass passage; and,
The fan blade is located near a forward end of the inner spool and acts to force the bypass flow through the central bypass passage.

22. The two-spool gas turbine engine of claim 19, and further comprising:
The first and second bearing support means comprises a guide vane located upstream of the combustor and a nozzle located downstream of the combustor.

23. The gas turbine engine of claim 3, and further comprising:
The bypass fan extends through the entire central bypass passage.

24. The gas turbine engine of claim 3, and further comprising:
The bypass fan includes a forward bypass blade located near the forward end of the central bypass passage a rearward bypass fan blade located near the rearward end of the central bypass passage.

25. The two-spool gas turbine engine of claim 15, and further comprising:
The bypass fan extends through the entire central bypass passage.

26. The two-spool gas turbine engine of claim 15, and further comprising:
The bypass fan includes a forward bypass blade located near the forward end of the central bypass passage a rearward bypass fan blade located near the rearward end of the central bypass passage.

27. The two-spool gas turbine engine of claim 19, and further comprising:
The bypass fan extends through the entire central bypass passage.

28. The two-spool gas turbine engine of claim 19, and further comprising:
The bypass fan includes a forward bypass blade located near the forward end of the central bypass passage a rearward bypass fan blade located near the rearward end of the central bypass passage.

29. A process for operating a gas turbine engine having a bypass flow, the process comprising the steps of:
Providing for the gas turbine engine to have a central bypass passage to direct a first bypass flow through the engine; and,
Providing for the gas turbine engine to have an outer bypass passage to direct a second bypass flow through the engine.

30. The process for operating a gas turbine engine of claim 29, and further comprising the step of:
Providing for a rotary shaft of the compressor, the turbine, and the bypass fan to form the central bypass passage.

31. The process for operating a gas turbine engine of claim 29, and further comprising the steps of:
Providing for an outer spool to support a high pressure compressor blade and a high pressure turbine blade;
Providing for an inner spool to support a low pressure compressor blade, a low pressure turbine blade, and a bypass fan blade; and,
Providing for the inner spool to form the central bypass passage.

32. The process for operating a gas turbine engine of claim 31, and further comprising the step of:
Providing for the bypass fan blade to be located near an aft end of the inner spool.

33. The process for operating a gas turbine engine of claim 31, and further comprising the steps of:
Providing for a mixer located downstream of the turbine to mix the turbine exhaust with the bypass flow; and,
Providing for bearing means to rotatably support the inner spool, the bearing means being supported by the mixer.

34. The process for operating a gas turbine engine of claim 31, and further comprising the steps of:
Providing for the bypass fan blade to extend substantially through the central bypass passage.

35. The process for operating a gas turbine engine of claim 31, and further comprising the steps of:
Providing for the bypass fan to include a fan blade located near the aft end of the inner spool and a fan blade located near the rear end of the inner spool.
